(19) United States
(12) Patent Application Publication
(10) Pub. No.: US 2013/0219337 A1
(43) Pub. Date: Aug. 22, 2013

(54) ELECTRONIC DEVICE, STORAGE MEDIUM AND METHOD FOR ARRANGING ICONS OF APPLICATIONS OF THE ELECTRONIC DEVICE

(71) Applicant: CHUN-KAI HWANG, Tu-Cheng (TW)

(72) Inventor: CHUN-KAI HWANG, Tu-Cheng (TW)

(73) Assignee: CHI MEI COMMUNICATION SYSTEMS, INC., Tu-Cheng (TW)

(21) Appl. No.: 13/594,861

(22) Filed: Aug. 26, 2012

(30) Foreign Application Priority Data
Feb. 16, 2012 (TW) 101105016

(51) Int. Cl. G06F 3/048

(52) U.S. Cl. 715/811

(57) ABSTRACT

In a method of an electronic device for arranging icons of applications of the electronic device, a starting time and an ending time of each of the applications is recorded in a storage system of the electronic device each time that the applications are run. A number of time intervals within a day are fixed, and a sample period is set, so that if a user of the electronic device selects an applications menu displayed on a display screen of the electronic device, the icons of each of the applications are arranged in the applications menu according to the counted running time of each of the applications.

### BACKGROUND

1. Technical Field

Embodiments of the present disclosure relate to data processing devices and methods, and more particularly to an electronic device, a storage medium, and a method for arranging icons of applications of the electronic device.

2. Description of Related Art

An electronic device, such as a mobile phone, a personal digital assistant, or a tablet computer, includes a plurality of applications, such as a media player application or a game application. To facilitate finding a desired application from the electronic device as soon as possible, icons of the applications of the electronic device may be arranged in an applications menu of the electronic device in descending order according to frequency of use. However, the frequency of use of the applications may be variable within different time periods. For example, a game application has a low frequency of use in the morning, but has a high frequency of use at night.

### BRIEF DESCRIPTION OF THE DRAWINGS

FIG. 1 is a block diagram of one embodiment of an electronic device including an icon arrangement system.

FIG. 2 is a flowchart of one embodiment of a method for arranging icons of applications of the electronic device of FIG. 1.

FIG. 3 is a schematic diagram illustrating an example of a running time of each of the applications.

FIG. 4 is a schematic diagram illustrating an example of arranging icons of the applications.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable storage medium include CDs, DVDs, BLU-RAY, flash memory, and hard disk drives.

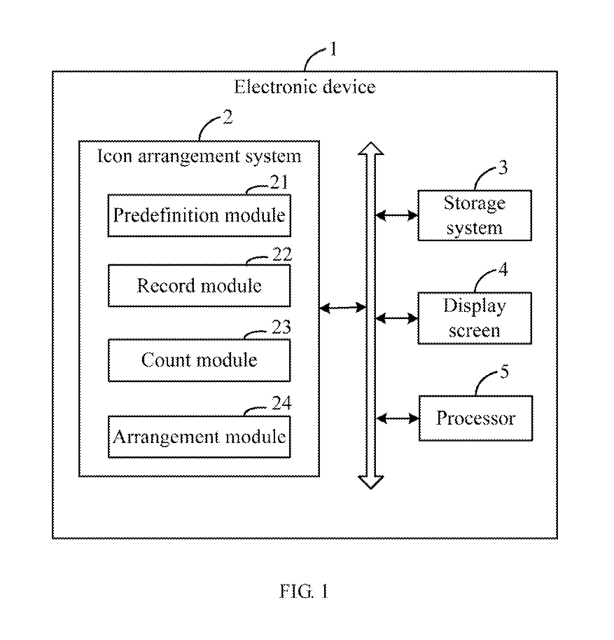

FIG. 1 is a block diagram of one embodiment of an electronic device 1 including an icon arrangement system 2. In the embodiment, the electronic device 1 further includes a storage system 3, a display screen 4, and at least one processor 5. The storage system 3 stores a plurality of applications, such as a media player application, a phone call application, or a game application. Each of the applications has a name and an icon. An icon of each application is arranged in an applications menu displayed on the display screen 4. The icon arrangement system 2 may be in form of one or more programs that are stored in the storage system 3 and executed by the at least one processor 5. FIG. 1 is just one example of the electronic device 1 that can be included with more or fewer components than shown in other embodiments, or have a different configuration of the various components.

In one embodiment, the storage system 3 may be a random access memory (RAM) for temporary storage of information, and/or a read-only memory (ROM) for permanent storage of information. In other embodiments, the storage system 3 may also be an external storage device, such as a storage card or a data storage medium. The at least one processor 5 executes operations and applications of the electronic device 1, to provide functions of the electronic device 1.

The icon arrangement system 2 arranges an order of the icon of each application in the applications menu according to a running time of each application in different time periods. The running time of an application is defined as a duration of time for which the application is running. A user of the electronic device 1 can start up a desired application by selecting an icon of the desired application from the applications menu on the display screen 4. The selecting can use a mouse, keyboard, or a touch screen depending on the embodiment.

In the embodiment, the icon arrangement system 2 may include a predefinition module 21, a record module 22, a count module 23, and an arrangement module 24. The modules 21-24 may comprise a plurality of functional modules each comprising one or more programs or computerized codes that are stored in the storage system 3, and can be accessed and executed by the at least one processor 5. A description of each module will be given.

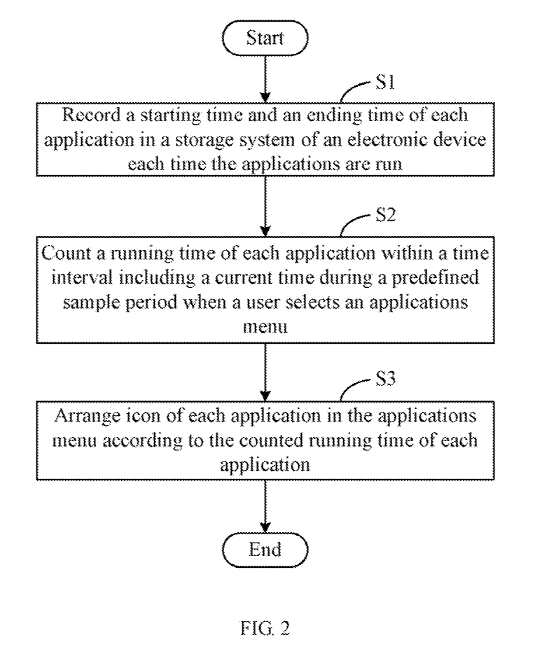

FIG. 2 is a flowchart of one embodiment of a method for arranging icons of applications of the electronic device 1 of FIG. 1. Depending on the embodiment, additional steps may be added, others removed, and the ordering of the steps may be changed.

Before step S1, the predefinition module 21 predefines a sample period and a division method for arranging the icons of the applications of the electronic device 1, and stores the predefined sample period and the division method in the storage system 3. The sample period can be defined as a recent past one or more days. For example, the sample period may be predefined as recent past seven days. If today is Saturday, the sample period would be from last Saturday to yesterday. The division method is defined as a method of dividing a day into several equal or unequal parts of time intervals. For example, the division method may divide a day into twenty four equal one-hour parts, where a first time interval is from 0:00 to 1:00, and a second time interval is from 1:00 to 2:00. For unequal parts, there may be division into sixteen unequal parts for example, where 8 am to 8 pm has twelve one-hour parts, and 8 pm to 8 am has four three-hour parts.

In step S1, the record module 22 records a starting time and an ending time of each application in the storage system 3 each time that the application is run (e.g., used either by clicked on, touched, manipulated). For example, the starting time of the game application may be 8:00 pm on Jan. 1, 2011, and the ending time of the game application may be 8:50 pm on Jan. 1, 2011.

In step S2, when the user selects the applications menu displayed on the display screen 4, the count module 23 counts a running time of each application within a time interval including a current time, by reference to the division method, during the sample period according to the recorded starting time and ending time of the running of each application.

For example, if the current time is 8:20, the one-hour equal parts time interval including the current time is from 8:00 to 9:00 according to the above example of the division method. Further, the game application was used three times during the recent past seven days. The first time of using the game application was from 8:45 to 9:15 on Tuesday, the second time of use was from 10:20 to 10:50 on Thursday, and the third time of use was from 8:20 to 8:30 on Friday. Therefore, the running time of the game application in the 8:00 to 9:00 time interval during the recent past seven days is (15 minutes on Tuesday plus 10 minutes on Friday) twenty five minutes.

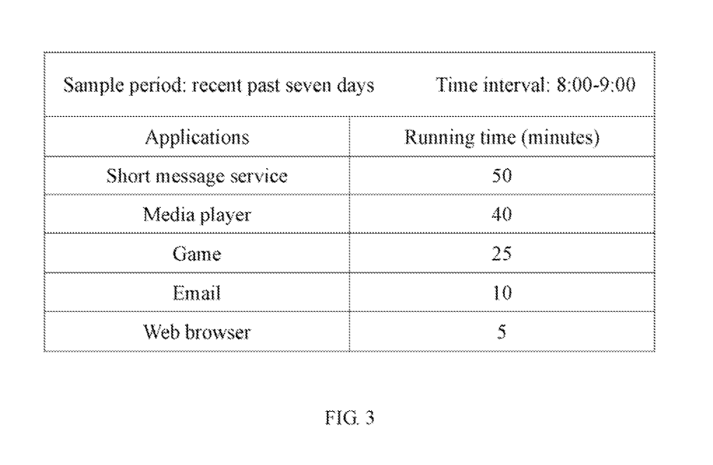

FIG. 3 is a schematic diagram illustrating an example of a running time of each of the applications. Referring to FIG. 3, the sample period is the recent past seven days, the time interval including the current time is from 8:00 to 9:00, the running time of a short message service application is fifty minutes, the running time of a media player application is forty minutes, the running time of the game application is twenty five minutes, the running time of an email application is ten minutes, and the running time of a web browser application is five minutes.

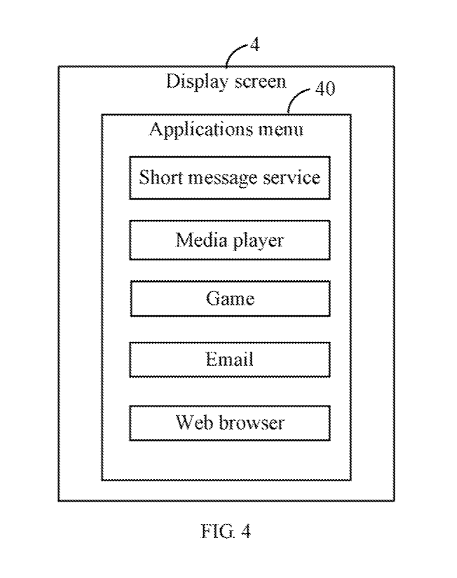

In step S3, the arrangement module 24 arranges the icon of each application in the applications menu according to the counted running time of each application within the time interval including the current time during the sample period. Referring to FIG. 4, the arrangement module 24 arranges the icon of each application in the applications menu 40 in descending order of the running time of each application in FIG. 3.

In summary, when the user considers the applications menu, an order of the icon of each application in the applications menu is presented according to the running time of each application within a recent past sample period, and furthermore, within the same time interval of a day. So, the order of the icon of each application in the applications menu at 7 am may be different with the order of the icon of each application in the applications menu at 7 pm. An icon of an application which has the longest running time is presented at top of the applications menu, and an icon of an application which has the shortest running time is presented at bottom of the applications menu.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system that stores a plurality of applications;
at least one processor;
a display screen that displays an applications menu;
one or more programs stored in the storage system and executed by the at least one processor, the one or more programs comprising:
a record module that records a starting time and an ending time of each of the applications in the storage system each time the applications are run;
a count module that counts a running time of each of the applications within a time interval comprising a current time during a predefined sample period according to the recorded starting time and ending time of each application, upon condition that a user of the electronic device selects the applications menu; and
an arrangement module that arranges icons of each of the applications in the applications menu according to the counted running time of each of the applications.

2. The electronic device of claim 1, wherein the one or more programs further comprise a predefinition module that predefines the sample period and a division method.

3. The electronic device of claim 2, wherein the sample period is defined as one or more days.

4. The electronic device of claim 2, wherein the division method is defined as a method of dividing a day into several equal or unequal parts of time intervals.

5. The electronic device of claim 1, wherein the arrangement module arranges the icons of each of the applications in the applications menu in descending order of the running time of each of the applications.

6. A method of an electronic device for arranging icons of applications of the electronic device, the method comprising:
(a) recording a starting time and an ending time of each of the applications in a storage system of the electronic device each time the applications are run;
(b) counting a running time of each of the applications within a time interval comprising a current time during a predefined sample period according to the recorded starting time and ending time of each application, upon condition that a user of the electronic device selects an applications menu displayed on a display screen of the electronic device; and
(c) arranging the icons of each of the applications in the applications menu according to the counted running time of each of the applications.

7. The method of claim 6, further comprising:
predefining the sample period and a division method.

8. The method of claim 7, wherein the sample period is defined as one or more days.

9. The method of claim 7, wherein the division method is defined as a method of dividing a day into several equal or unequal parts of time intervals.

10. The method of claim 6, wherein the step (c) further comprises:
arranging the icons of each of the applications in the applications menu in descending order of the running time of each of the applications.

11. A non-transitory storage medium storing a set of instructions, the set of instructions capable of being executed by a processor of an electronic device, causes the processor to execute a method for arranging icons of applications of the electronic device, the method comprising:
(a) recording a starting time and an ending time of each of the applications in a storage system of the electronic device each time the applications are run;
(b) counting a running time of each of the applications within a time interval comprising a current time during a predefined sample period according to the recorded starting time and ending time of each application, upon condition that a user of the electronic device selects an applications menu displayed on a display screen of the electronic device; and
(c) arranging the icons of each of the applications in the applications menu according to the counted running time of each of the applications.

12. The storage medium of claim 11, wherein the method further comprises:
predefining the sample period and a division method.

13. The storage medium of claim 12, wherein the sample period is defined as one or more days.

14. The storage medium of claim 12, wherein the division method is defined as a method of dividing a day into several equal or unequal parts of time intervals.

15. The storage medium of claim 11, wherein the step (c) further comprises:
arranging the icons of each of the applications in the applications menu in descending order of the running time of each of the applications.
